(19) United States
(12) Patent Application Publication
(10) Pub. No.: US 2025/0323334 A1
(43) Pub. Date: Oct. 16, 2025

(54) LITHIUM-ION BATTERY GAS GETTERS

(71) Applicant: FORD GLOBAL TECHNOLOGIES, LLC, Dearborn, MI (US)

(72) Inventor: Michael LERNER, Corvallis, OR (US)

(21) Appl. No.: 18/631,970

(22) Filed: Apr. 10, 2024

(51) Int. Cl. H01M 10/52; H01M 4/38; H01M 4/505; H01M 10/0525; H01M 10/0585; H01M 50/204

(52) U.S. Cl. CPC H01M 10/526; H01M 4/382; H01M 4/505; H01M 10/0525; H01M 10/0585; H01M 50/204

(57) ABSTRACT

This disclosure relates to systems and methods for gas mitigation. In one aspect of the disclosure, a battery is presented. The battery has a de-gassed lithium-manganese rich battery cell and a lithium-based anode packaged with a lithium-manganese-rich cathode, saturated in an electrolyte. A barium oxide-based coating is in the de-gassed lithium-manganese rich battery cell, and configured to convert oxygen and carbon dioxide into barium peroxide and carbonate and retain the barium peroxide and carbonate.

### TECHNICAL FIELD

The disclosure relates to gas mitigation for lithium-ion batteries.

### BACKGROUND

Lithium-ion batteries (LIBs) generate gasses during the initial charging and operational maintenance at certain potentials. This gas generation can occur at both the cathode and anode sides of the battery and is influenced by various factors. At the cathode, the generation of gases such as oxygen and carbon dioxide are observed. Oxygen can be released from nickel manganese cobalt oxide (NMC) or lithium-manganese-rich (LMR) cathodes, contributing to gas generation. Additionally, gas can be generated through interactions between the cathode surface and the electrolyte. This phenomenon is more pronounced during the battery's initial charge/discharge cycles, which are part of the cell formation and aging process. Although the rate of gas generation decreases following this phase, it continues at a reduced level during cell storage and cycling, particularly at high states of charge (SOC). Factors such as incomplete phase transformation during cell formation, cathode material particle fracturing, and exposure to extreme temperatures can contribute to ongoing gas generation.

After the formation phase, LIBs are sealed to contain the internal components and electrolyte. The accumulation of gases within this sealed environment can lead to internal pressurization. This, in turn, can lead to increased cell resistance. In all cell types, internal pressurization might affect the wetting of the separator, potentially leading to dry spots and lithium plating. The gases generated within the cell, specifically carbon dioxide and oxygen, can also interact with other cell components in ways that alter the battery's performance. For example, oxygen may convert metals and anode materials, while carbon dioxide dissolved in the electrolyte can alter its viscosity, ionic conductivity, stability, as well as cause other issues.

### SUMMARY

In one aspect of the disclosure, a battery is presented. The battery has a de-gassed lithium-manganese rich battery cell having a lithium-based anode packaged with a lithium-manganese-rich cathode, saturated in an electrolyte. A barium oxide-based coating is in the de-gassed lithium-manganese rich battery cell, configured to convert oxygen and carbon dioxide gas into barium peroxide and carbonate and retain the barium peroxide and carbonate. The battery may be a prismatic cell, pouch cell, or cylindrical cell. The polymer sheath may be fluoropolymer-based.

In another aspect of the disclosure, a battery pack is presented. The battery includes a plurality of lithium-manganese rich battery cell assemblies defining a stack. A binary metal oxide-based coating with a polymer sheath, on interior surfaces of the stack, is configured to convert oxygen and carbon dioxide gas into binary metal peroxide and carbonate and encapsulate the binary metal peroxide and carbonate. The binary metal oxide-based coating may contain an alkaline earth metal. The alkaline earth metal may be magnesium or barium. The polymer sheath may be fluoropolymer-based. The plurality of lithium-manganese rich battery cell assemblies may be prismatic cells, cylindrical cells, or pouch cells.

In yet another aspect of the disclosure, a manufacturing method is presented. The method includes packaging a lithium-based anode with a lithium-manganese-rich cathode, saturating the lithium-based anode and the lithium-manganese-rich cathode with an electrolyte to form a lithium-manganese rich battery cell, de-gassing the lithium-manganese rich battery cell to form a de-gassed lithium-manganese rich battery cell, and then applying a binary oxide-based coating to interior surfaces of the de-gassed lithium-manganese rich battery cell. In some configurations, the method may include selecting low surface area particles of binary oxide-based material before inserting the binary oxide-based material into the de-gassed lithium-manganese rich battery cell. In other configurations, the de-gassing includes cooling the lithium-manganese rich battery cell. In even more configurations, a polymer sheath may be applied to the binary oxide-based coating. Optionally, the method may include sealing the de-gassed lithium-manganese rich battery cell. In some configurations, the binary oxide-based coating may be mixed with a solvent prior to application.

### BRIEF DESCRIPTION OF THE DRAWINGS

FIG. 1. is a schematic view of a battery pack according to one or more embodiments of the disclosure;

FIG. 2. is a schematic view of a battery cell according to one or more embodiments of the disclosure; and

FIG. 3. is a flowchart of a manufacturing method according to one or more embodiments of the disclosure.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In the development of LIBs, particularly those with high-NMC or LMR cathodes and other high-voltage cells, managing the formation and accumulation of gases such as oxygen and carbon dioxide is a factor. NMC refers to a class of cathode material that combines nickel, manganese, and cobalt in various ratios to achieve a balance of energy density. LMR cathodes, on the other hand, contain a higher concentration of lithium and manganese. These gases are byproducts of the cell formation process and can continue to accumulate during the battery's operational life, potentially affecting its performance and longevity.

During the LIB cell formation process, interactions between the electrodes and electrolyte result in the creation of passivation layers known as the solid-electrolyte interphase (SEI) on the anode and the cathode-electrolyte interphase (CEI) on the cathode. While these layers are necessary for the normal operation of the battery, preventing direct contact between the electrodes and electrolyte, the formation process itself leads to the generation of oxygen and carbon dioxide.

Gas getters in LIBs refer to materials that absorb or chemically react with gases, such as oxygen and carbon dioxide, generated during battery operation. The materials may be metal oxides and specifically alkaline earth metals. These getters play a role in maintaining battery integrity and performance by mitigating internal pressurization and chemical instability. Strategies to optimize the performance and extend the lifespan of these gas getters within the battery cells are proposed. These include applying an inert, low-porosity polymer layer to the getters, adding the getters during or after the battery cell's degassing step, or selecting getters with low surface areas to slow down reaction and saturation rates.

To address the presence of these gases within the sealed battery environment, the use of metal oxides as reactive agents capable of transforming carbon dioxide into carbonates through the reaction MO(s)+CO₂(g)→MCO₃(s) is explored. The effectiveness of these reactions is influenced by the metal oxide's properties and the conditions within the battery cell, such as temperature and moisture levels. Among these metal oxides, barium oxide is notable for its ability to react with both carbon dioxide and oxygen—the latter reaction producing a stable peroxide, BaO(s)+1/2O₂(g)→BaO₂(s).

This disclosure outlines an approach that incorporates a de-gassed lithium-manganese-rich battery cell with a lithium-based anode and a lithium-manganese-rich cathode, immersed in an electrolyte. This cell has a barium oxide-based coating designed to facilitate the oxidation of oxygen and carbon dioxide into barium peroxide and carbonate, thereby sequestering these gases. The concept may be extended to a battery pack configuration that integrates multiple such cells, each leveraging this gas management strategy to potentially increase the battery's overall performance and durability. This approach mitigates gas formation during the initial cell formation and degassing steps, and also actively manages gas accumulation throughout the battery's operational life.

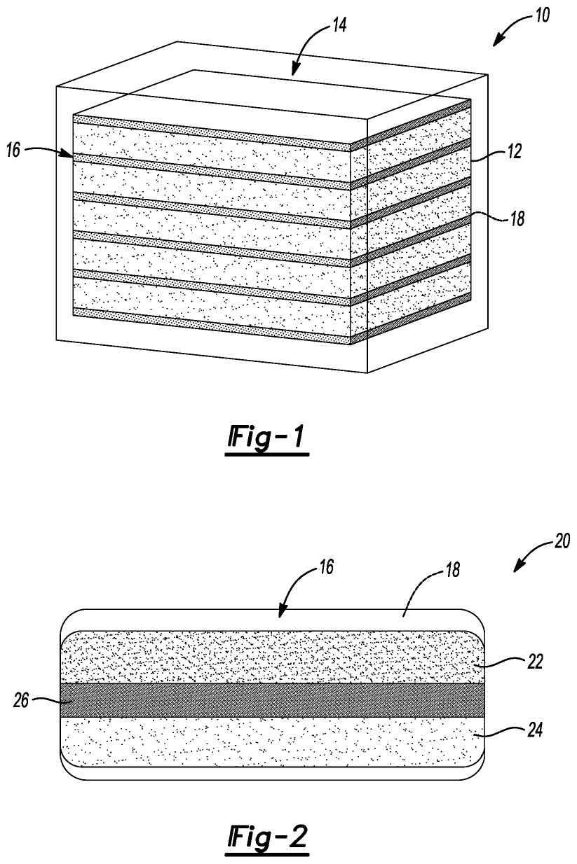

Referring to FIGS. 1-2, FIG. 1 illustrates a schematic view of a battery pack 10 with multiple lithium-manganese rich battery cell assemblies 12 arranged to form a stack 14. The lithium-manganese rich battery cell assemblies 12 may be any suitable type of battery cell assemblies such as prismatic cells, cylindrical cells, or pouch cells. The battery pack 10 includes binary metal oxide-based coating 16 on the interior surfaces of the stack 14. This coating 16 is developed to facilitate the conversion of oxygen and carbon dioxide gases into binary metal peroxide and carbonate. After this conversion the byproducts are retained within the coating 16, contributing to the maintenance of the internal environment of the battery cell, which in turn, supports the longevity and performance of the battery.

The binary metal oxide-based coating 16 contains an alkaline earth metal. The alkaline earth metal for the binary metal oxide-based coating 16 may be magnesium, barium, or any other suitable alkaline earth metal. The binary metal oxide-based coating 16 has a polymer sheath 18. The polymer sheath 18 may be made of fluoropolymer materials, for the durability of the coating 16 and moderating the interaction between the coating 16 and internal gases.

In FIG. 2, a schematic diagram of a de-gassed lithium-manganese rich battery cell 20 is shown. The de-gassed lithium-manganese rich battery cell 20 is packaged with a lithium-based anode 22 and a lithium-manganese-rich cathode 24, saturated in an electrolyte 26. The binary metal oxide-based coating 16 is a barium oxide-based coating in the de-gassed lithium-manganese rich battery cell 20. The coating 16 may be applied to any interior surfaces of the cell 20 in any suitable manner, to convert oxygen and carbon dioxide gas into barium peroxide and carbonate and retain the barium peroxide and carbonate. The lithium-manganese rich battery cell 20 may be any suitable type of battery cell such as a prismatic cell, cylindrical cell, or pouch cell. The coating 16 may also include the polymer sheath 18. The polymer sheath 18 may also be made of fluoropolymer materials, for the durability of the coating 16 and moderating the interaction between the coating 16 and internal gases. The polymer sheath 18 included in the binary metal oxide-based coating 16 serves to moderate the interaction between the coating 16 and the internal gases of the battery cell 20. The moderated interaction of the coating 16 and the internal gases of the battery cell 20 may prevent the immediate saturation of the coating by moderating its exposure to oxygen and carbon dioxide.

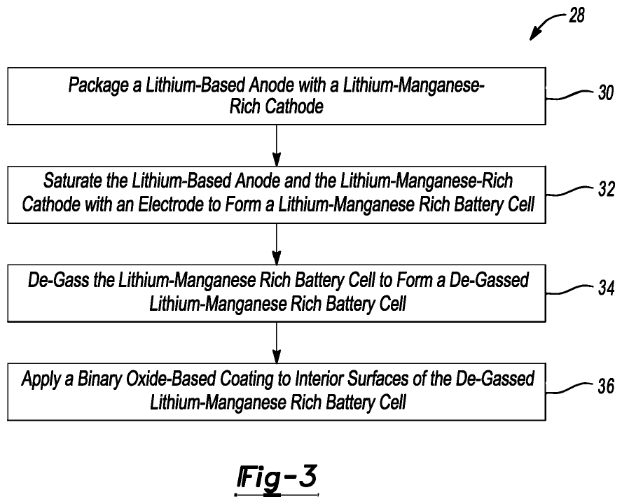

FIG. 3 is a flowchart of a manufacturing method 28 according to one or more embodiments of the disclosure. A first block 30, involves packaging a lithium-based anode with a lithium-manganese-rich cathode. Then in block 32, it involves saturating the lithium-based anode and the lithium-manganese-rich cathode with an electrolyte to form a lithium-manganese rich battery cell. In block 34, de-gassing the lithium-manganese rich battery cell is performed to form a de-gassed lithium-manganese rich battery cell. In block 36, it involves inserting a binary oxide-based material into the de-gassed lithium-manganese rich battery cell. In some configurations, the method 26 may include selecting low surface area particles of binary oxide-based material before inserting the binary oxide-based material into the de-gassed lithium-manganese rich battery cell. Selecting particles of the binary oxide-based material with a low surface area before inserting them into the de-gassed lithium-manganese rich battery cell may mitigate saturation. Lower surface area particles exhibit a moderated rate of reactivity with internal gases. By adjusting the surface area of these particles, the method 28 promotes a steady rate of interaction between the coating and internal gases, such as oxygen and carbon dioxide. This steady interaction may prevent immediate saturation of the coating, contributing to the sustained efficacy and stability of the de-gassed lithium-manganese rich battery cell over its lifespan.

In some embodiments, the method 26 may include cooling the lithium-manganese rich battery cell during de-gassing. In other embodiments, the method 26 may further include applying a polymer sheath to the binary oxide-based coating. In some configurations, the method 26 further includes sealing the de-gassed lithium-manganese rich battery cell. In other configurations, the binary oxide-based coating may be mixed with a solvent prior to application.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A battery comprising:
a de-gassed lithium-manganese rich battery cell having a lithium-based anode packaged with a lithium-manganese-rich cathode, saturated in an electrolyte; and
a barium oxide-based coating in the de-gassed lithium-manganese rich battery cell, configured to convert oxygen and carbon dioxide into barium peroxide and carbonate and to retain the barium peroxide and carbonate.

2. The battery of claim 1 wherein the de-gassed lithium-manganese rich battery cell is a prismatic cell.

3. The battery of claim 1 wherein the de-gassed lithium-manganese rich battery cell is a pouch cell.

4. The battery of claim 1 wherein the de-gassed lithium-manganese rich battery cell is a cylindrical cell.

5. The battery of claim 1 wherein the barium oxide-based coating includes a polymer sheath.

6. The battery of claim 5 wherein the polymer sheath is fluoropolymer-based.

7. A battery pack comprising:
a plurality of lithium-manganese rich battery cell assemblies defining a stack; and
a binary metal oxide-based coating with a polymer sheath, on interior surfaces of the stack, configured to convert oxygen and carbon dioxide into binary metal peroxide and carbonate and to encapsulate the binary metal peroxide and carbonate.

8. The battery pack of claim 7 wherein the binary metal oxide-based coating contains an alkaline earth metal.

9. The battery pack of claim 8 wherein the alkaline earth metal is magnesium.

10. The battery pack of claim 9 wherein the alkaline earth metal is barium.

11. The battery pack of claim 7 wherein the polymer sheath is fluoropolymer-based.

12. The battery pack of claim 7 wherein the plurality of lithium-manganese rich battery cell assemblies are prismatic cells.

13. The battery pack of claim 7 wherein the plurality of lithium-manganese rich battery cell assemblies are cylindrical cells.

14. The battery pack of claim 7 wherein the plurality of lithium-manganese rich battery cell assemblies are pouch cells.

15. A method comprising:
packaging a lithium-based anode with a lithium-manganese-rich cathode;
saturating the lithium-based anode and the lithium-manganese-rich cathode with an electrolyte to form a lithium-manganese rich battery cell;
de-gassing the lithium-manganese rich battery cell to form a de-gassed lithium-manganese rich battery cell; and
inserting a binary oxide-based material into the de-gassed lithium-manganese rich battery cell.

16. The method of claim 15, further comprising selecting low surface area particles of binary oxide-based material before inserting the binary oxide-based material into the de-gassed lithium-manganese rich battery cell.

17. The method of claim 15 wherein the de-gassing includes cooling the lithium-manganese rich battery cell.

18. The method of claim 15, further comprising applying a polymer sheath to the binary oxide-based coating.

19. The method of claim 15, further comprising sealing the de-gassed lithium-manganese rich battery cell.

20. The method of claim 15 wherein the binary oxide-based coating is mixed with a solvent prior to application.
